(19) United States
(12) Patent Application Publication
(10) Pub. No.: US 2018/0149234 A1
(43) Pub. Date: May 31, 2018

(54) HEAVY-DUTY BICYCLE CHAIN STRUCTURE

(71) Applicant: WEN-PIN WANG, TAINAN CITY (TW)

(72) Inventor: WEN-PIN WANG, TAINAN CITY (TW)

(21) Appl. No.: 15/364,761

(22) Filed: Nov. 30, 2016

(51) Int. Cl. F16G 13/06

(52) U.S. Cl. CPC F16G 13/06

(57) ABSTRACT

A heavy-duty bicycle chain structure includes two oppositely disposed inner link plates, a link roller, a sleeve, two oppositely disposed outer link plates, and a link pin. The link roller lies between the inner link plates, which are each at least 1.5 mm thick. The sleeve is pivotally connected to the inner link plates and the link roller and has a first pin hole 4.05±0.1 mm in diameter. Each outer link plate has two ends each formed with a second pin hole 4.05±0.1 mm in diameter. The link pin has a diameter of 4.0±0.2 mm, is placed in the first pin hole and the corresponding pair of second pin holes, and is thus pivotally connected to the sleeve and the outer link plates. The bicycle chain structure features a large contact area between the link pin and the sleeve and hence high tensile strength.

### BACKGROUND OF THE INVENTION

### 1. Technical Field

The present invention relates to a heavy-duty bicycle chain structure. More particularly, the invention relates to a bicycle chain structure with a link pin of a large diameter and two inner link plates of a great thickness so as to increase the area of contact between the link pin and a sleeve, the rigidity of the inner link plates, and hence the tensile strength of the bicycle chain structure, thereby ensuring the safety of cycling.

### 2. Description of Related Art

Referring to FIG. 3, the conventional bicycle chain structure is formed by providing a link roller A3 and a sleeve A4 between two oppositely disposed outer link plates A1 as well as two oppositely disposed inner link plates A2, and then inserting a link pin A5 through the sleeve A4 to connect all the components securely together. According to bicycle chain-related requirements in Chinese National Standards and Japanese Industrial Standards, the tensile strength of a bicycle chain should be at least 820 kgf. While this tensile strength requirement is met by all commercially available bicycle chains nowadays (which typically feature a tensile strength of 850 kgf) and is sufficient for bicycles ridden in an ordinary manner, the same requirement is inadequate for bicycles used in performances that involve a rider driving a bicycle rapidly into the air and then falling from a great height, for the gravitational acceleration of the rider and the bicycle will create a far greater stress on the bicycle when the bicycle lands than when the bicycle is running on level ground. This enormous stress tends to exceed the tensile strength of a common bicycle chain and may break the chain as a result, putting the rider's life in danger. Generally, the chain breaks because the link pin A5, usually 3.61±0.02 mm in diameter, cannot withstand the huge pulling force acting on it. Also, the outer link plates A1 and the inner link plates A2, whose thickness is 1.0 mm in most cases, do not provide the necessary tensile strength. The chains of performing bicycles, therefore, pose considerable risks.

### BRIEF SUMMARY OF THE INVENTION

In view of the above, the present invention provides a heavy-duty bicycle chain structure, wherein the bicycle chain structure includes two oppositely disposed inner link plates, a link roller, a sleeve, two oppositely disposed outer link plates, and a link pin.

Each of the two inner link plates is at least 1.5 mm thick and has two ends each formed with a first pivotal connection hole of a diameter of 5.8±0.2 mm. The link roller is penetrated by a second pivotal connection hole of a diameter of 5.8±0.2 mm, has an outer diameter of 7.7±0.05 mm and a length of 2.3±0.2 mm, and is provided between the two oppositely disposed inner link plates such that the second pivotal connection hole corresponds to a corresponding pair of first pivotal connection holes of the two inner link plates. The sleeve is put in the corresponding pair of first pivotal connection holes and the second pivotal connection hole and is thereby pivotally connected to the two inner link plates and the link roller. The sleeve is penetrated by a first pin hole of a diameter of 4.05±0.1 mm and has an outer diameter of 5.6±0.2 mm. Each of the two outer link plates is at least 1.0 mm thick and has two ends each formed with a second pin hole of a diameter of 4.05±0.1 mm. The two outer link plates are adjacent to the two inner link plates respectively such that a corresponding pair of second pin holes of the two outer link plates correspond to the first pin hole. The link pin is put in the first pin hole and the corresponding pair of second pin holes and is thereby pivotally connected to the sleeve and the two outer link plates. The link pin has a diameter of 4.0±0.2 mm.

The foregoing technical features produce the following effects:

1. By increasing the diameter of the link pin and modifying the dimensions of the related components correspondingly, the area of contact between the link pin and the sleeve is enlarged to achieve a high tensile strength and even distribution of stress.

2. According to the present invention, a tensile strength of at least 1200 kgf can be obtained such that wear resistance, and hence the service life, of the bicycle chain structure are increased. The high tensile strength helps ensure bicycle riders' safety.

3. According to the present invention, the inner link plates are at least 1.5 mm thick and are therefore thicker than their conventional counterparts, which are 1.0 mm thick. Nevertheless, the inner link plates of the present invention still comply with the requirements of Chinese National Standards and Japanese Industrial Standards regarding the link pitch (P) and the inner link (L) of a ½×⅛ bicycle chain, namely the reference pitch value of 12.7 mm and the minimum inner width of 3.4 mm of an inner link.

### BRIEF DESCRIPTION OF THE SEVERAL VIEWS OF THE DRAWINGS

FIG. 1 is an exploded perspective view of the present invention;

FIG. 2 is an assembled sectional view of the present invention, marked with dimensions; and

FIG. 3 is an assembled sectional view of a conventional chain structure, marked with dimensions.

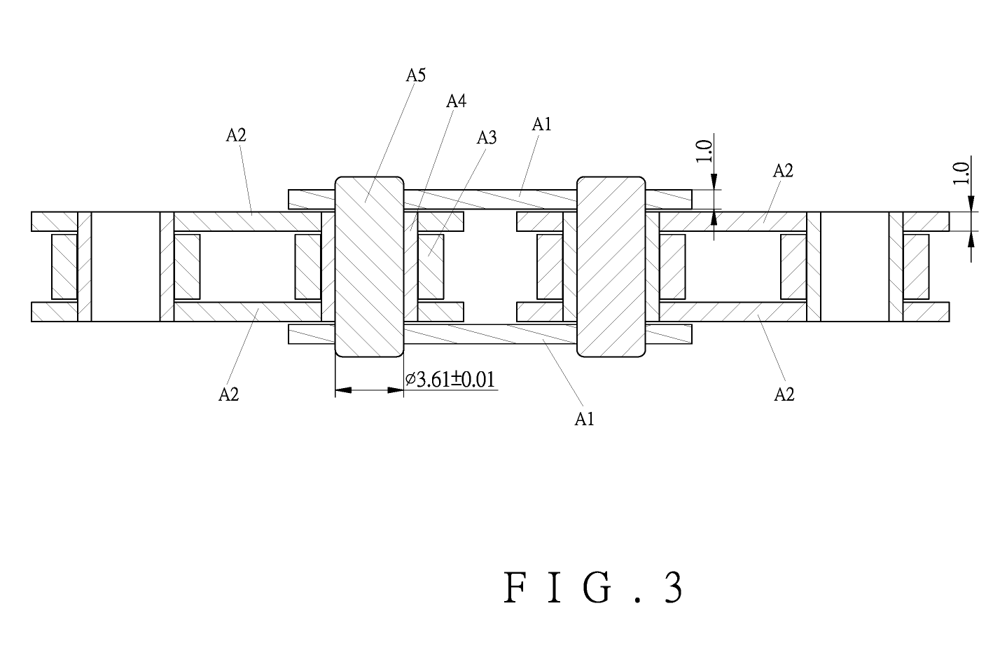

### DETAILED DESCRIPTION OF THE INVENTION

The present invention incorporates the aforesaid technical features into a heavy-duty bicycle chain structure. The major effects of the bicycle chain structure are detailed below with reference to an illustrative embodiment.

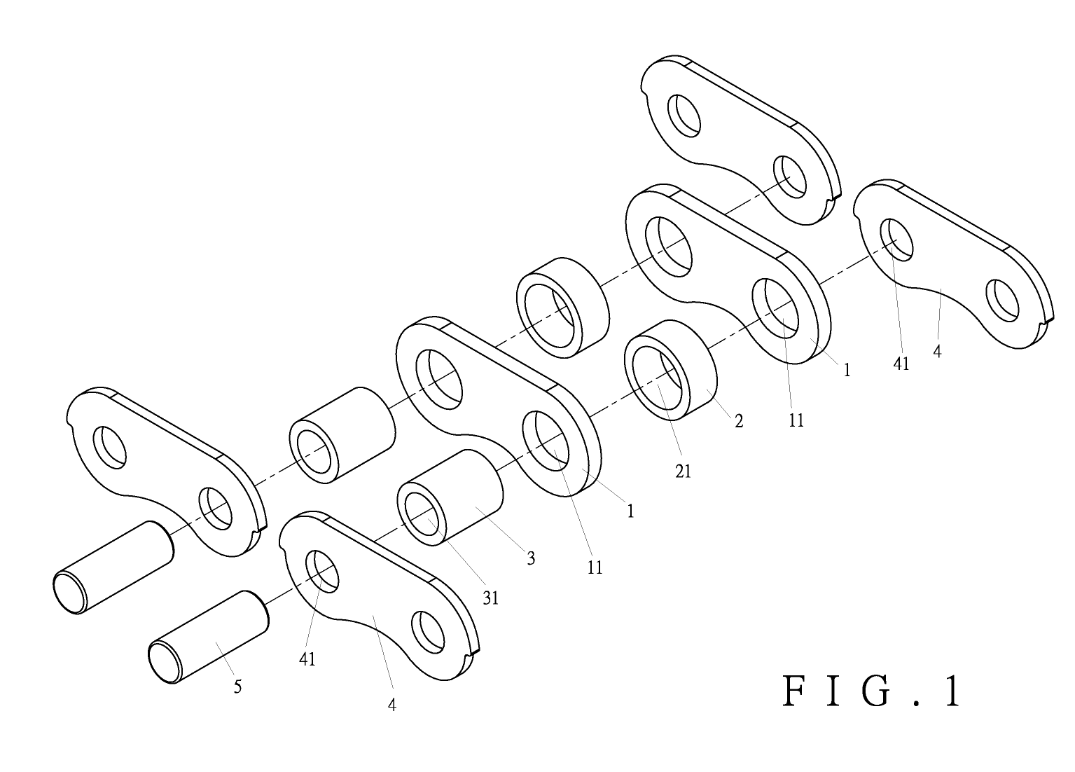

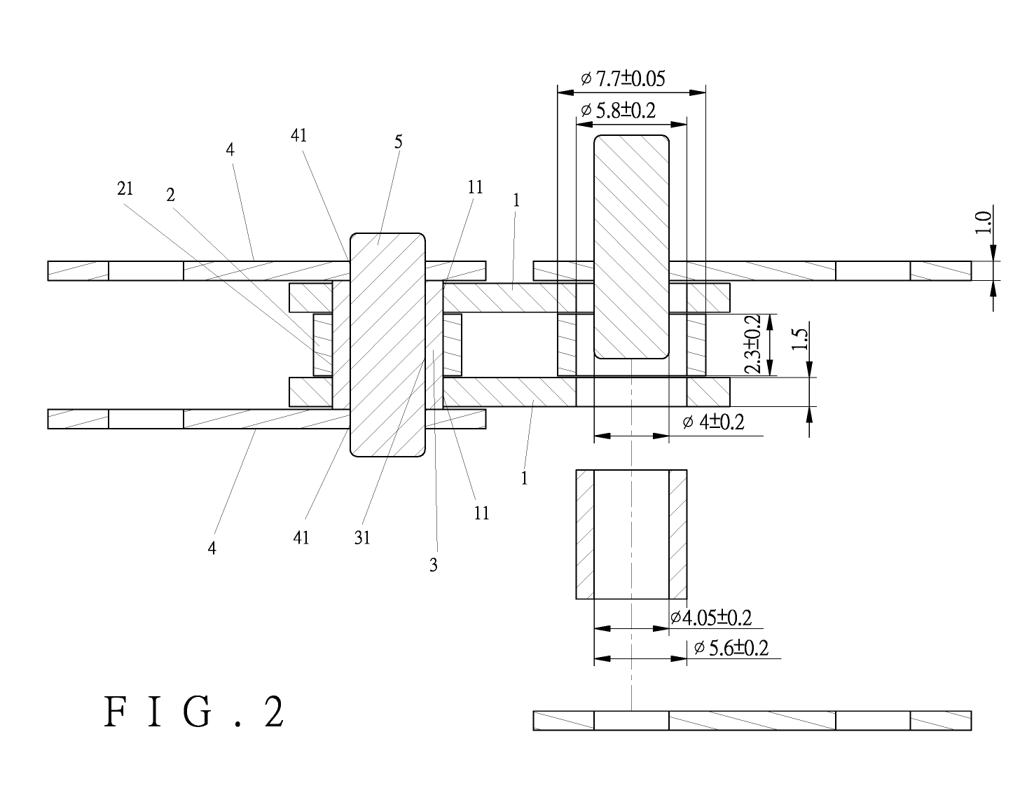

Referring to FIG. 1 and FIG. 2, an embodiment of the present invention includes two oppositely disposed inner link plates 1, a chain roller 2, a sleeve 3, two oppositely disposed outer link plates 4, and a link pin 5.

Each of the two inner link plates 1 is at least 1.5 mm thick. In addition, each inner link plate 1 has two ends each formed with a first pivotal connection hole 11 of a diameter of 5.8±0.2 mm. The link roller 2 is penetrated by a second pivotal connection hole 21 of a diameter of 5.8±0.2 mm and has an outer diameter of 7.7±0.05 mm and a length of 2.3±0.2 mm. The link roller 2 is provided between the two oppositely disposed inner link plates 1 such that the second pivotal connection hole 21 corresponds to a corresponding pair of first pivotal connection holes 11 of the two inner link plate 1. The sleeve 3 is placed in the corresponding pair of first pivotal connection holes 11 and the second pivotal connection hole 21 and is thereby pivotally connected to the two inner link plates 1 and the link roller 2. The sleeve 3 is penetrated by a first pin hole 31 of a diameter of 4.05±0.1 mm and has an outer diameter of 5.6±0.2 mm. Each of the two outer link plates 4 is at least 1.0 mm thick. Also, each outer link plate 4 has two ends each formed with a second pin hole 41 of a diameter of 4.05±0.1 mm. The two outer link plates 4 are adjacent to the two inner link plates 1 respectively such that the corresponding pair of second pin holes 41 of the two outer link plates 4 correspond to the first pin hole 31. The link pin 5 is placed in the first pin hole 31 and the corresponding pair of second pin holes 41 and is thereby pivotally connected to the sleeve 3 and the two outer link plates 4. The link pin 5 has a diameter of 4.0±0.2 mm.

To assemble, referring to FIG. 2, the link roller 2 is placed between the two inner link plates 1, with the corresponding pair of first pivotal connection holes 11 of the two inner link plates 1 in alignment with the second pivotal connection hole 21 of the link roller 2. Next, the sleeve 3 is put into the corresponding pair of first pivotal connection holes 11 and the second pivotal connection hole 21. Then, the corresponding pair of second pin holes 41 of the two outer link plates 4 are aligned with the first pin hole 31 of the sleeve 3, and the link pin 5 is subsequently placed into the first pin hole 31 and the corresponding pair of second pin holes 41 to connect all the components securely together.

As mentioned above, the diameter of the link pin 5 is increased to 4.00±0.20 mm from the conventional diameter of 3.61±0.02 mm, the thickness of each inner link plate 1 is at least 1.5 mm, and the thickness of each outer link plate 4 is at least 1.0 mm. Now that the diameter of the link pin 5 is increased, its circumference is, too. The area of contact between the link pin 5 and the sleeve 3 is therefore larger than in the prior art to enable even distribution of stress, which together with the enhanced rigidity provided by the great thickness of the inner link plates 1 raises the tensile strength of the entire chain structure from the conventional 850 kgf to 1200 kgf or even 1500 kgf—a nearly 50% increase in tensile strength. As the large contact area also increases the structure's resistance to wear, the bicycle chain structure is expected to have a long service life. In particular, the link pin 5 in the bicycle chain structure will not be broken by the stress generated by falling from a great height as in a bicycle performance, and this helps ensure the bicycle rider's safety.

A full understanding of the operation, use, and intended effects of the present invention should be obtainable from the foregoing description of the embodiment. The disclosed embodiment, however, is but a preferred one of the invention and is not intended to be restrictive of the scope of the invention. All simple equivalent changes and modifications made according to the appended claims and the disclosure of this specification should fall within the scope of the present invention.

What is claimed is:

1. A heavy-duty bicycle chain structure, comprising:
two oppositely disposed inner link plates, wherein each said inner link plate is at least 1.5 mm thick and has two ends each formed with a first pivotal connection hole of a diameter of 5.8±0.2 mm;
a link roller penetrated by a second pivotal connection hole of a diameter of 5.8±0.2 mm, wherein the link roller has an outer diameter of 7.7±0.05 mm and a length of 2.3±0.2 mm and is provided between the two oppositely disposed inner link plates such that the second pivotal connection hole corresponds to a corresponding pair of said first pivotal connection holes of the two inner link plates;
a sleeve placed in the corresponding pair of first pivotal connection holes and the second pivotal connection hole and thus pivotally connected to the two inner link plates and the link roller, wherein the sleeve is penetrated by a first pin hole of a diameter of 4.05±0.1 mm and has an outer diameter of 5.6±0.2 mm;
two oppositely disposed outer link plates, wherein each said outer link plate is at least 1.0 mm thick and has two ends each formed with a second pin hole of a diameter of 4.05±0.1 mm, and the two outer link plates are adjacent to the two inner link plates respectively such that a corresponding pair of said second pin holes of the two outer link plates correspond to the first pin hole; and
a link pin placed in the first pin hole and the corresponding pair of second pin holes and thus pivotally connected to the sleeve and the two outer link plates, wherein the link pin has a diameter of 4.0±0.2 mm.
